(19) United States
(12) Patent Application Publication
(10) Pub. No.: US 2022/0207285 A1
(43) Pub. Date: Jun. 30, 2022

(54) CLASSIFIER SYSTEM AND METHOD FOR GENERATING CLASSIFICATION MODELS IN A DISTRIBUTED MANNER

(71) Applicant: AICURA MEDICAL GMBH, Berlin (DE)

(72) Inventors: Sebastian NIEHAUS, Buxtehude (DE); Michael DIEBOLD, Berlin (DE); Daniel LICHTERFELD, Berlin (DE)

(21) Appl. No.: 17/609,252

(22) PCT Filed: May 11, 2020
(86) PCT No.: PCT/EP2020/063047

§ 371 Date: Nov. 5, 2021

(30) Foreign Application Priority Data
May 10, 2019 (EP) 19173947.3
Oct. 2, 2019 (EP) 19201156.7

(51) Int. Cl. G06K 9/62; G06N 3/04

(52) U.S. Cl. CPC G06K 9/628; G06N 3/0454

(57) ABSTRACT

The invention relates to a classifier system for classifying states of a system that is characterized by measurable system parameters, or for classifying objects, which classifier system has a plurality of decentralized, i.e. local, classifier units and a central classifier unit. The decentralized classifier units can be clients, for example, and the central classifier unit can be a server in a client-server system. In this type of system, the decentralized classifier units are formed (trained) in a decentralized manner and subsequently combined centrally to form binary classifier units which, in turn, can form a multiclass classifier unit.

The invention relates to a classifier system which comprises a plurality of federated binary classifier units and to a method for generating classification models in a distributed manner.

Binary classifier units are designed to assign an object described by parameter values or a state of a system described by parameter values to one of two classes, wherein the classes can mean possible states or objects, for example. If the system, whose state is to be classified, can only assume two states, e.g. state A or state B, a binary classifier unit can form, from an input data set containing measured or derived input parameter values, a membership value as an output value that indicates which of the two possible states the parameter values belong to, i.e. which of the two possible states the system assumed at the time when the parameter values were measured. The membership value does not necessarily have to be unique, but can also indicate a probability that the input parameter values belong to state A or to state B. A possible membership value can thus be e.g. 0.78 and mean that the system was in state A with a probability of 78% and in state B with a probability of 22%.

If a system can assume more than two states, an assignment can nevertheless be made with the help of several binary classifier units in that a respective binary classifier unit determines the degree of probability that the system is in one of the possible states. If the system can assume one of the states A, B, or C, for example, a first classifier unit can be designed to form a membership value that indicates the degree of probability that the system is in state A. This classifier unit thus assigns the input parameter values either to state A or to state not-A. Correspondingly, a second classifier unit can be designed to generate a membership value that indicates the degree of probability that the system is in state B. This second classifier unit thus assigns the input parameter values either to state B or to state not-B. A third binary classifier unit can be designed to determine the membership with state B. The classifier units can be logically connected in series so that a check for membership with state B only takes place if the check for membership with state A shows that the input parameter values are to be assigned to state not-A.

In addition to binary classifier units, there are also multiclass classifier units that can assign an object or system described by input parameter values to one of several classes (more than two classes), i.e. they can simultaneously create membership values for several possible objects or states. In the above example, a multiclass classifier unit can form four membership values, for example, namely one for state A, one for state B, one for state C, and one for state neither A nor B nor C.

Binary and multiclass classifier units can consist of artificial neural networks. Artificial neural networks have a topology made up of nodes and connections between the nodes and in which the nodes are organized in successive layers. The nodes of an artificial neural network are made up of artificial neurons that perform a weighted sum of one or several input values, and output an output value that is dependent on whether the sum of the weighted input values exceeds a threshold value. Instead of a fixed threshold value, an artificial neuron can apply a sigmoid function to the sum of the weighted input values, i.e. a kind of soft threshold at which the output value can also assume values between zero and one.

The input parameter values in an input data set are assigned to the artificial neurons (nodes) of an input layer. The artificial neurons of the input layer supply their output values as input values to typically several (or all) neurons of the next layer of the artificial neural network. A neuron in an output layer of the artificial neural network finally supplies the membership value that indicates the probability (or whether) the input parameter values belong to a certain state of a system or to a certain object. Typically, several intermediate layers (hidden layers) are provided between the input layer and the output layer; together with the input layer and the output layer, they define the topology of the neural network. A binary classifier unit can have two neurons in the output layer, namely one that supplies the membership value for class A and one that supplies the membership value for class not-A as the output value. A multiclass classifier unit can have several neurons in the output layer, namely one that supplies a membership value for one of the classes for which the multiclass classifier unit was trained, and another neuron that indicates the probability that the object described by the input parameter values or the state described by the input parameter values cannot be assigned to any of the classes for which the multiclass classifier unit was trained. A multiclass classifier unit can be formed by several binary sub-classification models in such a way that the multiclass classifier unit is composed of several parallel binary sub-classification models (hereinafter also referred to as binary sub-paths), each with their own intermediate layers (hidden layers), wherein the several parallel binary classification models have a common input layer and a common output layer.

Artificial neural networks especially suitable for image processing are convolutional neural networks in which a comparatively small convolutional matrix (filter kernel) is applied to a value matrix formed by input parameter values in a convolutional layer. The input values of a respective neuron are thus determined by means of a discrete convolution. The input values of a neuron in the convolutional layer are calculated as the inner product of the convolution matrix with the values of the input value matrix currently assigned in a respective step. The comparatively small convolution matrix is moved over the relatively larger input value matrix step by step, and the inner product is formed in each case.

Classifier unit and especially neural networks are typically characterized by their predetermined topology and by the model parameter values that define the weighting of the input values of a respective neuron and the function of the neuron. The function of the neuron defines how the informational value of the respective neuron results from its weighted input values. The function of a neuron can be a simple threshold value function and the associated model parameter value would then be the associated threshold value. However, the function of the neuron can also be a sigmoid function, for example, which can be parameterized by appropriate model parameter values. Together, all model parameter values define a classification model which, in combination with the topology of the neural network, defines the respective classifier unit.

The model parameter values for a respective classifier unit are determined through training. During training (also referred to as learning phase in the context of machine learning), both the input parameter values and the associated class (as target value) are specified for a classifier unit. In the manner known to the person skilled in the art, the model parameter values for the classifier unit are then determined in an optimization process in such a way that a high membership value for the target value (i.e. the specified class) results when the classifier unit processes an input data set with system parameter values as specified during training.

The specified topology of a classifier unit and the model parameter values determined through training define a respective classification model that can typically be described solely by the set of underlying model parameter values, since the underlying topology is specified. A classification model is thus defined, for example, by the topology of the underlying artificial neural network and by the model parameter values.

Important model parameter values are typically the weights used for weighting the different input values of a respective neuron. During the learning phase, the weights are optimized step by step in an iterative process in such a way that the deviation between a specified target value (i.e. a specified class) and the initial value of the classifier unit is as small as possible. The deviation between the specified target value and the output value of the classifier unit can be assessed using a quality criterion, and the weights can be optimized using a gradient algorithm in which a typically quadratic quality criterion is optimized, i.e. the minima of the quality criterion are searched for. A minimum is approximated by means of a known gradient algorithm that determines the gradients by which the weights change from iteration step to iteration step. Larger gradients correspond to a larger change per iteration step and small gradients correspond to a smaller change per iteration step. In the vicinity of a searched for (local) minimum of the quality criterion, the changes in the weights from iteration step to iteration step—and thus the corresponding gradient—are typically relatively small. The gradients can be used to determine respective weight changes for the next iteration step. The iterative optimization is continued until a specified abort criterion is met, e.g. the quality criterion has reached a specified level, or a defined number of iteration steps has been reached.

Since the system parameter values of different states or objects of the same class can differ, a classifier unit is trained with a plurality of more or less different input data sets for a respective class, and the model parameter values are determined in the course of the optimization process in such a way that they provide the most reliable membership value possible for a respective class in spite of individual deviating system parameter values. For example, if a specified class for an object is “rose” and the system parameter values are pixels of a photo that represent the color and brightness of a pixel in the photo, the color of the rose petals is obviously less important than, for example, their shape in order to assign the object shown in the photo to the “rose” class. The training of a respective classifier unit with many different photos of roses will likely lead to input values as a function of the color of the petals being weighted less in the final analysis than input values as a function of the shape of the petals, which leads to correspondingly adapted model parameter values.

If the input data sets used for training are too similar or if too few input data sets representing different variants of the same object or state are available for training, the known overfitting can occur. If, for example, a classifier unit for the object “rose” was only trained with photos of red roses, it is quite possible that such a classifier unit only determines a low membership value for photos of white roses, although white roses are roses just like red roses.

One option to avoid such overfitting at least partially consists of training different classifier units on different data sets for the same class (or in the case of multiclass classifier units, for the same classes) and to combine the model parameter values obtained by means of different classifier units. This is known as “distributed learning”. The efficient combining of the models and their model parameter values can pose problems here.

The models can be combined during training, but also after training—that is, during or after the learning phase. In practice, combining the gradients is particularly relevant. The gradients represent the model changes—in particular the change in the weights for the input values of the neurons —between the individual optimization steps that a machine learning algorithm takes during the learning phase in order to optimize the model parameters. It is a fact that the model changes (gradients) are combined after each or after n model updates (iteration steps). This way, a global model (for a central classifier unit) is formed only using local gradients of local models that were generated by decentralized classifier units. Such generation of central classification models by combining models generated in a decentralized manner is known, inter alia, from “Federated Learning” of the company Google (Alphabet).

The invention proposes a classifier system for classifying states of a system that is characterized by measurable system parameters or for classifying objects, which system has a plurality of decentralized, i.e. local, classifier units and a central classifier unit. The decentralized classifier units can be clients, for example, and the central classifier unit can be a server in a client-server system. In this type of system, the decentralized classifier units are formed (trained) in a decentralized manner and subsequently combined centrally to form binary classifier units, which in turn can form a multiclass classifier unit.

A classifier unit can implement one or several classification models. In particular, the central classifier unit can implement several binary classification models and also a multiclass classification model, for example. A central multiclass classification model can, for example, be generated from two or several decentralized binary models for different classes. The decentralized classifier units can also be implemented by one or several binary classification models and/or by one or several multiclass classification models composed of binary classification models. Model updates of such combined models will then only pertain to relevant model paths.

If the classifier unit is created on the basis of artificial neural networks, a respective classification model is defined, for example, by the topology of the underlying artificial neural network and by the model parameter values. Model parameters are e.g. coefficients of the function defining a respective artificial neuron (a sigmoid function, for example) and the weights used for weighting the input values of the artificial neurons.

The state of the system to be classified or the object to be classified is described by measurable or derived system parameter values. Derived system parameter values can, for example, describe relations between measured system parameter values, e.g. distributions or differences, mean values, etc.

The decentralized classifier units are designed to determine, on the basis of model parameter values specific to a respective decentralized classifier unit, a membership value for a (respective) input data set formed by system parameter values of the measurable system parameters, which membership value shows the membership to a state or object class of a state or object represented by the data set formed by the system parameter values of the measurable system parameters.

The central classifier unit is connected to the decentralized classifier units for transmission of model parameter values defining classification models. For example, the model parameter values generated by the decentralized classifier units are transferred to a central processing unit which, as a result, forms a central (multiclass) classification model and thus defines the central classifier unit.

The model parameter values of a respective classification model defined in a decentralized classifier unit are generated by training the decentralized classifier unit with training data sets made up of locally determined system parameter values and an associated predefined state or object class. The state or object class assigned to a respective training data set establishes a target value. A training data set represents an input data set for the classifier unit to be trained and, together with the target value, forms a training data tuple.

The target value belonging to a respective training data tuple (i.e. the specified class, also referred to as “label”) can be specified explicitly by a user, e. g. in that the user selects a target value from a predefined list of possible target values, which target value matches the respective input data set. Specification by a user can also be made in the form of a textual description from which the target value is then extracted by means of language processing (NLP, natural language processing). If training data is generated, for example by incorporating an image or entering information, the user can provide the associated target value via a user interface created for this purpose, or it can be generated automatically based on the user behavior (for example from a report using natural language processing). After the target value has been generated, the associated decentralized binary classification model is updated, and the data used for training as part of the update, i.e. the system parameter values, no longer need to be saved. This is particularly advantageous in the medical field for reasons of data protection.

Preferably, at least one of the decentralized classifier units is designed to update, in case of a new training data set for a state class, the respective decentralized binary classification model for this state class and to transmit the updated model parameter values resulting therefrom and/or gradients obtained as part of the update to the central classifier unit. In this context, the central classifier unit is preferably designed to update, in response to the receipt of updated model parameter values and/or gradients, only the central binary classification model or the central sub-classification model of a multiclass classification model that has been trained for the affected state class.

The classifier system has several different decentralized classifier units, for which the decentralized model parameter values of a respective classification model are the result of training the respective decentralized classifier unit with training data sets, which are different measured system parameter values of the respectively same system parameters and a target value representing a state of the system characterized by these system parameters, which target value represents the membership of the system parameter values contained in the training data set to a state class.

The central classifier unit is designed to generate central model parameter values from decentralized model parameter values originating from different decentralized classifier units, formed on the basis of the measured system parameter values of the respectively identical system parameters, and/or from gradients occurring in the course of modeling (iterative optimization), which central model parameter values define a central classification model for the state class assigned to the system parameters.

Preferably, the central classifier unit is also designed to derive central model parameter values for a central multiclass classification model on the basis of central model parameter values that define binary classification models or binary sub-classification models of one or several decentralized multiclass classification models for different classes, and/or on the basis of gradients occurring in the course of modeling (iterative optimization). This can also be done only for individual sub-classification models, for example also when updating a central classification model using updated decentralized model parameter values.

The central classifier unit is preferably designed to transmit (back) central model parameter values generated by it to one or several decentralized classifier units so that the respective decentralized classifier unit represents the respective central classification model. The respective decentralized classifier unit can, in this case and in this way, also be a multiclass classifier unit. It is also possible that only parts, i.e. individual binary classification models, of a central multiclass classification model implemented by the central classifier unit are transmitted back to one or several decentralized classifier units.

The invention takes into account the findings that the approximation of classification models using machine learning methods requires a sufficiently large training data set or training data sets with a class distribution that is as consistent as possible. These distributions are usually only available for data sets that have been prepared in a complex manner and only for problem domains that allow the compilation of such data sets.

The invention further takes into account the findings that these training data sets often cannot be compiled in practical use for reasons of data protection. Data sets are distributed across different decentralized units which may produce different distributions in the data sets. These different distributions occur as a result of a specific focus of the respective decentralized units or due to external factors of the decentralized units (e.g. geographic patterns). As a result, the models approximated on the decentralized units are over-adapted to the present distribution and, in some places, models on individual decentralized units only map part of the classes (i.e. the possible states, for example).

It can also not be determined whether there is enough data per class at all since quantitative studies in advance are not possible because of the distribution.

The classifier system according to the invention can be operated with a method that comprises the training of binary classification models on decentralized classifier units that are separate from each other. The method also includes transferring the models and combining the binary classification models from the decentralized classifier units to form a multiclass classification model. Models of different types can also be used. The combining of models does not have to be a combining of complete models, but can also be a combining of individual gradients or model changes.

The method can be as follows, for example:
1. A training input data tuple (consisting of an input data set that contains system parameter values and the target value that specifies a class) is divided into n (n=number of classes) data tuples, each with a binary target value.
2. Each data tuple is used to update the model parameter values of m (m=number of different initializations) classifier units of the same type (i.e. with the same topology). This step must be carried out for at least one model type, but can be carried out with any number of model types.
3. Each set of model parameter values that was formed by the central classifier unit is then preferably made available as a validation data set. If overfitting occurs, an update of a respective set of model parameter values is aborted.
4. Manual termination of an update of a respective set of model parameter values on a decentralized classifier unit is also possible, since there is no convergence in some models.
5. After all update processes have been terminated, the model parameter values are sent to the central classifier unit.
6. The binary classification models defined by corresponding sets of central model parameter values are combined by the central classifier unit for each class and each model type to form a respective central binary classification model, and central binary classifier units are thus defined.
7. Each central binary classifier unit is then preferably validated using a global validation data set.
8. The validation and the combination of the binary classification models can be repeated as often as required.
9. All central binary classification models are then combined to form a central multiclass classification model for all classes. Up to this process step, it can be decided to which classes the central multiclass classification model should be limited.

A method according to the invention comprises the following steps:
Decentralized formation of several binary classification models for a target value;
Transmission of model parameter values and/or gradients defining a respective binary classification model to a central classifier unit; and
Formation of a central binary classification model from the transmitted model parameter values and/or by the central classifier unit.

The method preferably also comprises the following step:
Formation of a central multiclass classification model from a plurality of binary classification models by the central classifier unit.

The method can also comprise the following step:
Transmission of model parameter values defining a central classification model to one or several decentralized classifier units.

Model parameter values and/or gradients defining a respective binary classification model are preferably transmitted to the central classifier unit after each update of a decentralized binary classification model, or at fixed intervals or as a function of intervals defined by a parameter, or after the formation of a respective decentralized binary classification model has been completed.

The following terms are used in this description:

The system parameter values are parameter values that describe a technical or biological system, for example an object such as a machine, a data processing system, a part of the body, a plant, or the like.

The system parameter values can also be parameter values that describe a state of a technical or biological system, for example a functional state, an operating state, an error state, a state of health, a training state, or the like.

System parameters are measurable parameters, e.g. dimensions, mass, distances, brightness, temperature, etc., or parameters derived from measurable parameters, e.g. value distributions, differences, mean values, etc.

A respective system parameter value is a measured or derived (numerical) value of a respective system parameter.

System parameter values that belong together can form an input data set that has a structure which is used to uniquely assign the (numerical) system parameter values contained in the data set to a respective system parameter.

A classification model can, for example, be defined by a trained artificial neural network or a model defined by coefficients of a linear regression that supplies one or several membership value(s) as output value(s) that each show the membership of the parameter values contained in the structured input data sets to a respective system state.

Model parameters can be weights of a trained neural network or coefficients of a linear regression, and model parameter values are then the (numerical) values of the respective weights of a trained neural network or the coefficients of a linear regression.

The system parameter values (in each case) result in an input data set for the local binary classifier units.

In the case of implementation in the form of a neural network, the individual system parameter values of an input data set are weighted in the input layer (and the resulting internal values (output values of the nodes) in the following layers). The weights can be extracted as model parameter values and transmitted in the form of a matrix to the central classifier unit, for example.

During the training phase, the model parameter values are generated in a decentralized manner by training the decentralized classifier units locally using input data sets containing system parameter values and the associated binary target value (class).

The model parameter values and/or gradients generated in a decentralized manner can be transmitted to the central classifier unit and, if necessary, to other decentralized classifier units.

The different decentralized classifier units can be trained for different binary target values (i.e. for different classes).

From the transmitted model parameter values and/or gradients, the central classifier unit generates several central binary classification models into which the model parameter values of all those decentralized classifier units that have been trained for this class are entered for a respective class. The central classifier unit can also combine different binary classification models into a central multiclass classification model.

After the training phase, the classification models generated centrally (centrally generated sets of model parameter values) are reflected back to the decentralized classifier units (deployment). If the centrally generated classification model is a multiclass classification model, only parts of this multiclass classification model can be transferred back to one or several of the decentralized classifier units (partial deployment).

During the application phase, the centrally generated classification models (i.e. classification models based on the centrally generated model parameter values) are applied by the decentralized classifier units. These classification models are preferably multiclass classification models, but can also be binary classification models which, together with the topology specified in each case, define a multiclass class classifier unit or a binary classifier unit.

Only model parameter values and the associated class (i.e. the associated binary target value) are transmitted to the central classifier unit, but no system parameter values are transmitted. This ensures data protection with regard to the system parameter values, e.g. photos.

The invention will now be described using an example and referencing the figures. The figures show the following:

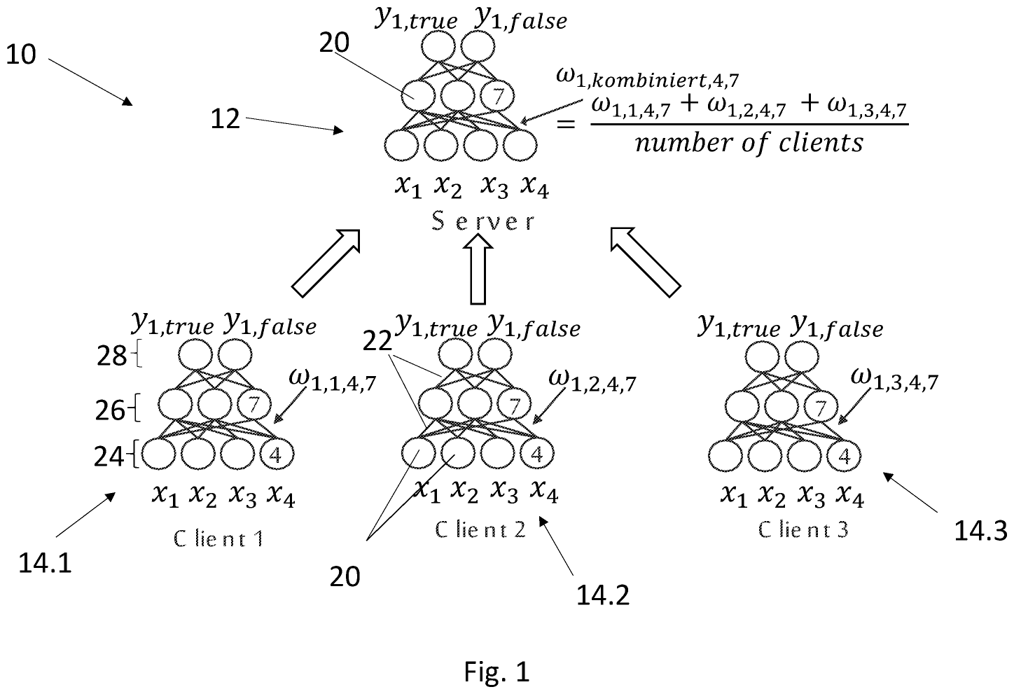

FIG. 1: Combining of several decentralized binary classification models to form a central binary classification model;

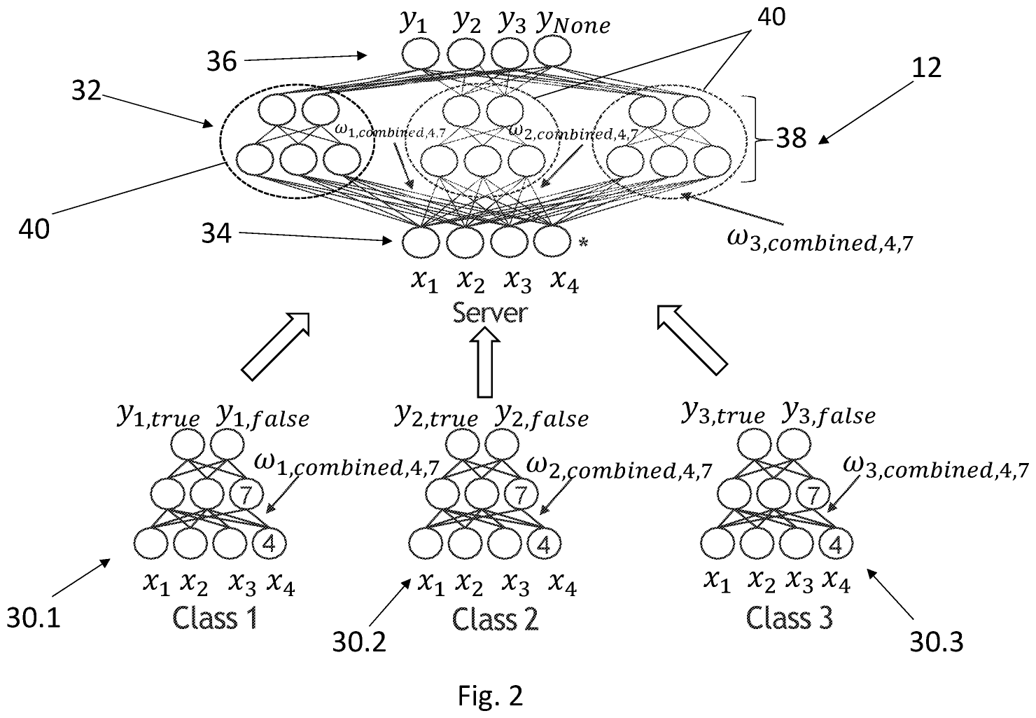

FIG. 2: Forming of a multiclass classification model from several (central) binary classification models; and

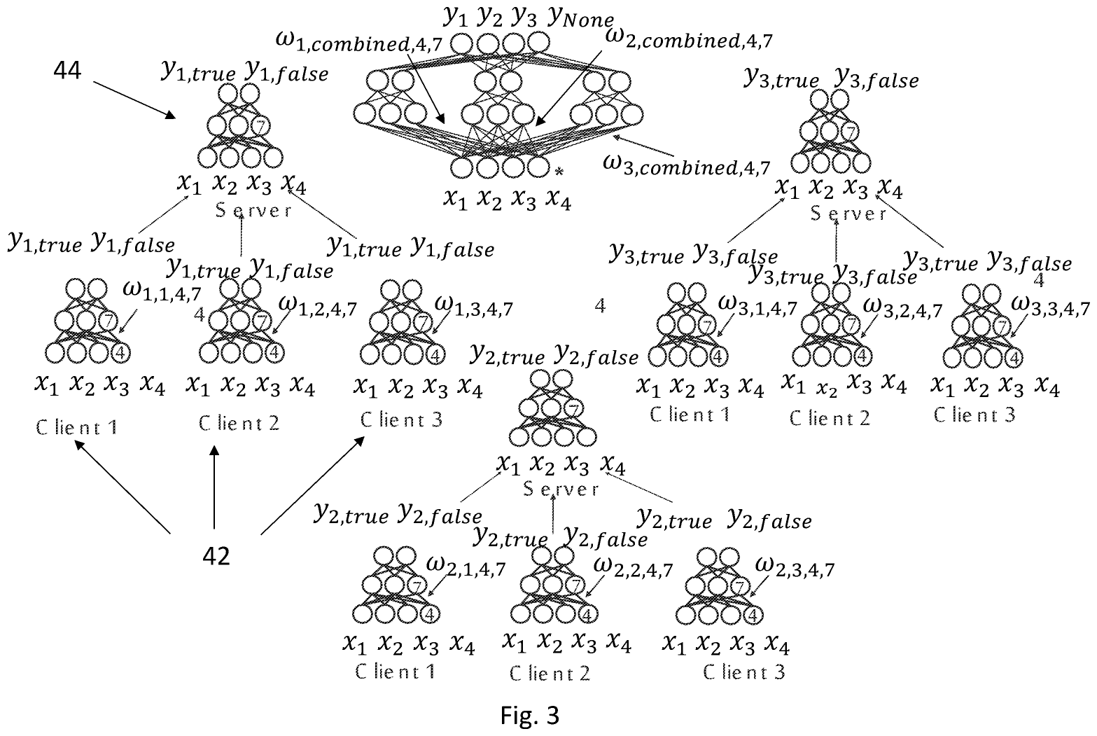

FIG. 3: A two-step method for the distributed generation of classification models.

FIG. 1 shows, by way of example, a classifier system 10 with a central classifier unit 12 and three decentralized classifier units 14.1, 14.2 and 14.3. The central classifier unit 12 can be implemented in the form of a server in a server-client network. The decentralized classifier units 14.1, 14.2, 14.3 can then be clients in the server-client network.

In the exemplary embodiment shown, both the central classifier unit 12 and the decentralized classifier units 14.1, 14.2, 14.3 each implement classification models that are defined by artificial neural networks.

Implementation of the artificial neural networks is identical for the depicted classifier units 12, 14.1, 14.2, and 14.3. This means that the artificial neural networks implemented in the classifier units each have an identical topology. The topology of a respective artificial neural network is defined by artificial neurons 20 and connections 22 between the artificial neurons 20. The artificial neurons 20 thus form nodes in a network. The artificial neurons 20 are arranged in several layers in a manner known in principle, namely in an input layer 24, one or several hidden layers 26, and an output layer 28.

In a respective artificial neural network of a respective classifier unit 12, 14.1, 14.2, 14.3, the neurons 20 receive a plurality of input values that are weighted and added up, resulting in a cumulative value to which a step or sigmoid function is applied that supplies an output value which is a function of the cumulative value and the applied sigmoid or step function. This output value of a respective artificial neuron 20 is transmitted as input value to one or several—typically all—artificial neurons 20 of a subsequent layer. This way the artificial neurons 20 of a subsequent, for example hidden, layer, e.g. layer 26, receive their input values, which in turn are individually weighted and added up. The cumulative values formed in this manner are in turn converted into output values in each of the neurons 20, for example via a sigmoid or step function.

The artificial neurons 20 of the output layer 28 each supply an output value, which is a membership value that indicates the probability for a state or an object, characterized by the system parameter values supplied to the artificial neurons 20 of the input layer 26, to be assigned to a specific class of objects or states. One of the artificial neurons 20 of the output layer 28 indicates the probability that the system parameter values provided in the form of an input data set describe a system that is to be assigned to a certain class (y _{1, true}), and a second artificial neuron of the output layer 28 indicates the probability that the system described by the system parameter values contained in an input data set are not to be assigned to the state (y _{1, false}). The binary classifier unit defined by the respective artificial neural network thus provides two membership values, namely one that indicates the probability of belonging to a class for which the artificial neural network was trained, and a second membership value that indicates the probability that the system described by the system parameter values of the input data set does not belong to the class for which the artificial neural network was trained.

In the exemplary embodiment shown, both the decentralized classifier units 14.1, 14.2 and 14.3, and the central classifier unit 12 each implement only a single neural network. It is possible that each of the classifier units 12, 14.1, 14.2 and 14.3 also implement several neural networks. The neural networks can also be different from each other in terms of their topology. It is only important that the neural networks for a specific object or state class are arranged identically both in the decentralized classifier units 14.1, 14.2 and 14.3, and in the central classifier unit 12.

A classification model for one class (in the case of binary classification models) or for several classes (in the case of multiclass classification models) is defined by the topology of a respective artificial neural network and the associated model parameter values. Here, model parameter values are the values of the weights w, that are used for weighting the input values of the individual neurons 20, as well as coefficients that describe the function of the artificial neurons 20, for example the sigmoid function or the threshold value of a step function. In a known topology, a classification model is thus clearly described by the model parameter values.

In a specified topology, the appropriate model parameter values are generated by training a respective artificial neural network with training data sets and an associated target value. The training data sets contain system parameter values and, together with the target value, form an input data tuple for the training (training data tuple). A target value indicates the class to which the system parameter values contained in the input data set are to be assigned. For example, the class can designate a certain object out of several objects or a certain state out of several states. As mentioned at the beginning, artificial neural networks are typically trained using a plurality of different training data tuples for the same class.

In the exemplary embodiment shown, the decentralized classifier units 14.1, 14.2 and 14.3 are typically trained using a plurality of different training data tuples, wherein the training data tuples that are used to train the first decentralized classifier unit 14.1, for example, differ from the training data tuples used to train the second decentralized classifier unit 14.2, since the respective system parameter values typically occur differently. This means that even if the artificial neural networks of all three decentralized classifier units 14.1, 14.2 and 14.3 are trained for the same class in each case, the resulting model parameter values and thus also the resulting classification models differ from each other to a greater or lesser extent.

To form a standardized (binary, in the example) central classification model, the decentralized classifier units 14.1, 14.2 and 14.3 each transmit the model parameter values of the classification model implemented by them to the central classifier unit 12. This classifier unit then combines the model parameter values in such a way that, for example, a mean value is generated from all model parameter values for a respective model parameter (i.e. respectively for a specific weight in the artificial neural network). This is indicated in FIG. 1 by the formula shown. The mean values generated in this manner are the model parameter values of the central classification model.

This way the central classifier unit 12 can form a central binary classification model for a specific class (index 1, for example).

FIG. 2 shows that a central classifier unit 12 can simultaneously implement several classification models that can be implemented by different artificial neural networks. In the example shown in FIG. 2, these are three different neural networks 30.1, 30.2 and 30.3, each of which defines a central binary classification model for a respectively different class (i.e. for a respectively different object or a completely different state).

The central classifier unit 12 is designed to form a combined multiclass classification model 32 from the three different binary classification models 30.1, 30.2 and 30.3 in the example. The multiclass classification model 32 is ultimately composed of three binary sub-classification models 40 that have a common input layer 34 and a common output layer 36, with each having their own intermediate layers 38 (hidden layers). If such multiclass classification model is implemented by the central classifier unit or one of the decentralized classifier units, it is possible to exchange only model parameters for one of the sub-classification models 40 between one of the local classifier units and the central classifier unit. For example, it can be defined that the transfer of model parameter values from a decentralized classifier unit to the central classifier unit always takes place when a (sub-) classification model implemented by the decentralized classifier unit has been updated with new training data sets, and updated decentralized, i.e. local, model parameter values were thus generated. This results in the central (multiclass) classification model implemented by the central classifier unit also being updated. The updated central model parameter values resulting therefrom can then, in turn, be transmitted from the central classifier unit to the corresponding decentralized classifier units in order to respectively update also the decentralized classification models implemented by them.

The result is thus a two-step method in which, in a first step, decentralized classification models 42 and, from these, several central binary classification models 44 are formed, and, in a second step, a multiclass classification model with several binary sub-classification models 40 (see FIG. 2) is formed from the central binary classification models 42. This is shown in FIG. 3.

The combined multiclass classification model 32 generated and implemented by the central classifier unit 12 as a result can then be transferred back to at least some of the decentralized classifier units (deployment), so that a classification model ultimately implemented by these decentralized classifier units is also optimized taking into account training data sets from other decentralized classifier units.

The back transfer (deployment) can also be done only partially in that, for example, only one or a selected few of the binary classification models 30.1, 30.2 and 30.3 are transmitted back, i.e. not the entire multiclass classification model implemented by the central classifier unit 12.

After the central classification model has been formed, this central classification model and, subsequently, the decentralized classification models can be updated as described above.

### LIST OF REFERENCE NUMBERS

10 Classifier system
12 Centralized classifier unit
14.1, 14.2, 14.3 Decentralized classifier unit
20 Neurons
22 Connection
24 Input layer
26 Hidden layer
28 Output layer
30.1, 30.2, 30.3 Neural network
32 Multiclass classification model
34 Input layer
36 Output layer
38 Intermediate layer
40 Binary sub-classification model
42 Decentralized classification model
44 Centralized binary classification models

1. A classifier system for classifying states of a system that is characterized by measurable system parameters, wherein the classifier system
features several decentralized classifier units that respectively implement one or several binary classification models or one or several multiclass classification models generated from/composed of binary classification models that are designed to
determine, for a (respective) data set generated by system parameter values of the measurable system parameters,
on the basis of model parameter values specific to a respective decentralized classifier unit,
a membership value that indicates the membership to a state class of a state represented by a data set generated by the system parameter values of the measurable system parameters;
and
features a central classifier unit that is connected to the decentralized classifier units for the transmission of model parameter values defining the classification models;
characterized in that the model parameter values of a respective decentralized classification model are generated by training the decentralized classifier unit with training data sets generated by locally determined system parameter values as input data sets, and an associated predefined state class as the target value;
wherein the classifier system has several different decentralized classifier units whose decentralized model parameter values are the result of training the respective decentralized classifier unit with training data sets, which are generated with different measured system parameter values of the respectively same system parameters and a target value representing a state of the system characterized by these system parameters, which target value represents the membership of the system parameter values contained in the training data set to a state class; and
wherein the central classifier unit is designed
to generate central model parameter values from decentralized model parameter values originating from different decentralized classifier units, generated on the basis of the measured system parameter values of the respectively identical system parameters that define a central binary classification model for the state class assigned to the system parameters; and
on the basis of central model parameter values that define binary classification models for different classes, to derive central model parameter values for a multiclass classification model and to thus form a central multi-classification model.

2. The classifier system according to claim 1, wherein the central classifier unit is designed to transfer central model parameter values generated by it to one or several decentralized classifier units so that the respective decentralized classifier unit represents the respective central classification model.

3. The classifier system according to claim 2, wherein the central classifier unit is designed to transmit central model parameter values of one or several binary sub-classification models of a central multiclass classification model to one or several decentralized binary classifier units.

4. The classifier system according to claim 1, wherein the central classifier unit and the decentralized classifier units implement classification models by means of artificial neural networks with a respectively identical topology that is defined by nodes and weighted connections between the nodes, which are formed by artificial neurons organized in several layers; and
the model parameter values are values of the weightings of the connections between the nodes and, if applicable, are threshold values of a respective neuron forming a node.

5. The classifier system according to claim 1, wherein
at least one of the decentralized classifier units is designed to update, in case of a new training data set for a state class, the respective decentralized binary classification model or sub-classification model for this state class and to transmit the updated model parameter values resulting therefrom and/or gradients obtained as part of the update to the central classifier unit,
wherein the central classifier unit is designed to update, in response to the receipt of updated model parameter values and/or gradients, only the central binary classification model or the central sub-classification model of a multiclass classification model that has been trained for the relevant state class.

6. The classifier system according to claim 1, wherein at least one of the decentralized classifier units is designed to obtain a target value for a training data set by way of language processing of a natural-language description of the state to which the locally determined system parameter values for the training data set belong.

7. A method for the distributed generating and updating of classification models, the method comprising the steps:
Decentralized formation of several binary classification models and/or of a multiclass classification model for one target value or several target values;
Transmission of model parameter values and/or gradients defining a respective binary classification model or binary sub-paths of a multiclass classification model to a central classifier unit; and
Formation or updating of a central classification model from the transmitted model parameter values by the central classifier unit.

8. The method according to claim 7, wherein the method additionally features the following step:
Formation of a central multiclass classification model from a plurality of binary classification models by the central classifier unit

9. The method according to claim 7, wherein the method additionally features the following step:
Transmission of model parameter values defining a central classification model to one or several decentralized classifier units.

10. The method according to claim 8, wherein only binary sub-classification models of a central multiclass classification model are transmitted to one or several decentralized classifier units.

11. The method according to claim 7, wherein the model parameter values and/or gradients defining a respective binary classification model or sub-classification model are transmitted to the central classifier unit after each update of a decentralized binary classification model or sub-classification model, or at fixed intervals or as a function of intervals defined by a parameter, or after the formation of a respective decentralized binary classification model or sub-classification model has been completed.
